(19) United States
(12) Patent Application Publication
(10) Pub. No.: US 2014/0189338 A1
(43) Pub. Date: Jul. 3, 2014

(54) ELECTRONIC DEVICE AND METHOD FOR DETECTING BOOTING TIME PERIOD FOR ELECTRONIC DEVICE

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: MIN YANG, Wuhan (CN); JIAN-HUNG HUNG, New Taipei (TW); XIN-SHU WANG, Wuhan (CN)

(73) Assignees: HON HAI PRECISION INDUSTRY CO., LTD., New Taipei (TW); HONG FU JIN PRECISION INDUSTRY (WuHan) CO., LTD., Wuhan (CN)

(21) Appl. No.: 14/140,555

(22) Filed: Dec. 26, 2013

(30) Foreign Application Priority Data
Dec. 29, 2012 (CN) 2012105886664

(51) Int. Cl. G06F 9/44

(52) U.S. Cl. CPC G06F 9/4401
USPC 713/2

(57) ABSTRACT

An electronic device includes a boot controlling chip, a power switch, a display unit, a power management unit and a processing unit. The power switch generates an electronic signal to the boot controlling chip while being triggered by a user. The boot controlling chip includes a boot sequence controlling module and a timer. The boot sequence controlling module controls the electronic device to boot in preset steps when the electronic signal is received. The timer starts timing when the electronic signal is received and ends timing when the boot sequence controlling module controls the electronic device to finish a login step of the boot steps, and the timer obtains a time of the interval. The processing unit controls the display unit to show the time value. A method for detecting boot time of an electronic device is also provided.

### BACKGROUND

1. Technical Field

The present disclosure relates to an electronic device and a method for detecting the booting time period for the electronic device.

2. Description of Related Art

Electronic devices, such as computers, intelligent mobile phones are installed with detection software for detecting the time period for booting, and for showing the detected data to the user. The detection software is activated after the operating system of the electronic device has been booted. The time of activating the electronic device is derived from the time data recorded in the Basic Input Output System (BIOS) of the electronic device, the BIOS records the start time of activation as the start time for booting the electronic device. The detection software records the time period for booting the electronic device started at the start time of activation of the BIOS and finishing at the finish time of the activation process. However, the true time period for booting the electronic device should be record between the time that the power key is depressed and the finish time of the activation process of the operating system of the electronic device. Thus, the conventional detection software detects inexact time period for booting the electronic device.

Therefore, what is needed is an electronic device and a method for detecting the booting time period for the electronic device to alleviate the limitations described above.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding sections throughout the several views.

FIG. 1 is a block diagram of an electronic device in accordance with an exemplary embodiment.

FIG. 2 is a flowchart of a method for detecting booting time period for electronic devices, such as the one of FIG. 1, in accordance with the exemplary embodiment.

### DETAILED DESCRIPTION

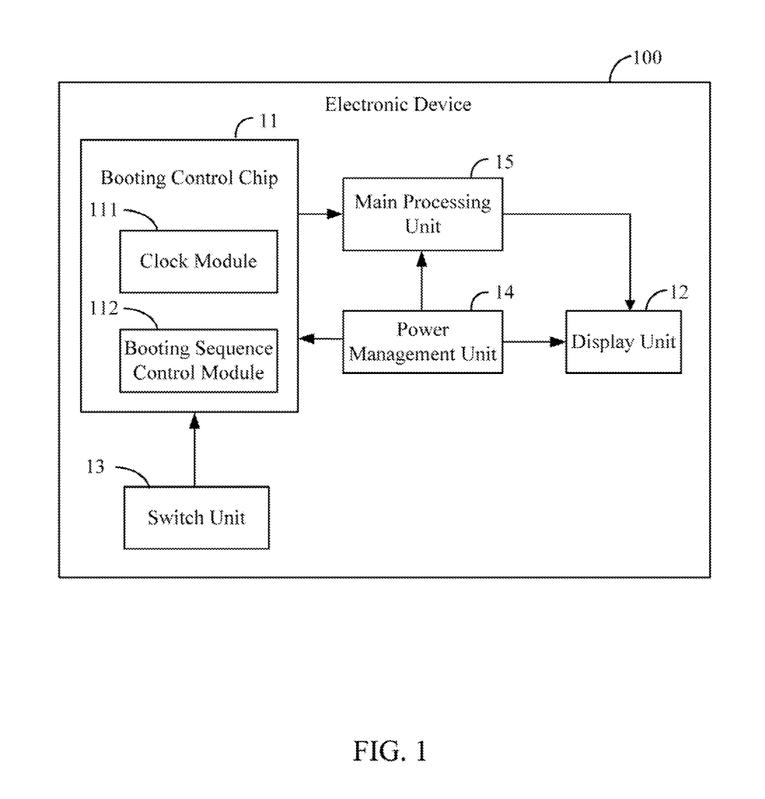

FIG. 1 is an exemplary embodiment of a block diagram of an electronic device 100. In the embodiment, the electronic device 100 is a computer. In alternative embodiments, the electronic device 100 can be other electronic devices, such as mobile phone, an electronic reader, a tablet, a digital phone frame, for example.

The electronic device 100 includes a booting control chip 11, a display unit 12, a switch unit 13, a power management unit 14, and a main processing unit 15. The booting control chip 11 is an embed controller (EC), and is used for controlling the booting sequence of the electronic device 100. The booting control chip 11 includes a clock module 111 and a booting sequence control module 112.

The power management unit 14 is electrically connected to the booting control chip 11, the display unit 12, and the main processing unit 15. The power management unit 14 is used for supplying power to the booting control chip 11, the display unit 12, and the main processing unit 15, etc.

The switch unit 13 is connected to the booting control chip 11, and sends an electric signal to the booting control chip 11 when triggered. In the embodiment, the switch unit 13 is electrically connected to a trigger pin 113 of the booting control chip 11. When the switch unit 13 is depressed, the switch unit 13 sends a logic high voltage level signal (i.e., the logic high level signal) to the trigger pin 113. When the trigger pin 113 receives the logic high voltage level signal, the clock module 111 of the booting control chip 11 starts timing, and records the time as the start time of the booting process. The booting sequence control module 112 controls the electronic device 100 to boot in sequence when the trigger pin 113 receives the high voltage signal. The booting of the electronic device 100 includes the following conventional steps: pre-guide, guide, loading inner core, initialization inner core, and logging in.

When the last booting step of the electronic device 100 finishes under the control of the booting sequence control module 112, the clock module 111 stops timing and records the time as the stop time of timing, and determines the value of the time period for booting the electronic device 100 according to the start time and the stop time of timing. That is, when the “logging in” step is over, the clock module 111 stops timing and determines the value of the time period. The clock module 111 also transmits the determined value of the time period to the main processing unit 15.

The main processing unit 15 receives the value of the time period for booting the electronic device 100 and controls the display unit 12 to display the value.

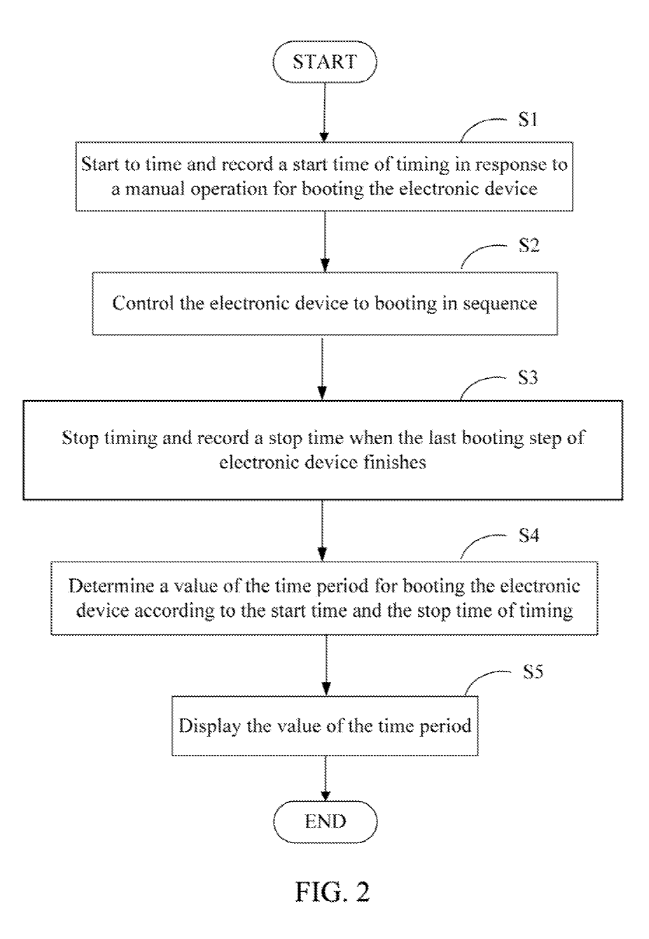

FIG. 2 shows a flowchart of a method for detecting time period for booting the electronic device 100 of FIG. 1. The method includes the following steps, each of which is related to the various components contained in the electronic device 100.

In step S1, the clock module 111 of the booting control chip 11 starts to time and records a start time of timing in response to a manual operation for booting the electronic device 100. In the embodiment, the switch unit 13 is manually depressed to trigger the booting process of the electronic device 100. When the switch unit 13 is depressed, the switch unit 13 sends a high voltage signal to the trigger pin 113. The clock module 111 of the booting control chip 11 starts to time and records the start time of when the trigger pin 113 receives the high voltage signal.

In step S2, the booting sequence control module 112 controls the electronic device 100 to booting in sequence when the trigger pin 113 receives the high voltage signal. The booting of the electronic device 100 includes the following conventional steps: pre-guide, guide, loading inner core, initialization inner core, and logging in.

In step S3, the clock module 111 stops timing and records a stop time when the last booting step of electronic device 100 finishes under the control of the booting sequence control module 112. In the embodiment, when the “logging in” step is over, the clock module 111 stops timing, records the stop time, and determines the value of the time period accordingly.

In step S4, the clock module 111 determines the value of the time period for booting the electronic device 100 according to the start time and the stop time of timing, and transmits the determined value of the time period to the main processing unit 15.

In step S5, the main processing unit 15 receives the value of the time period for booting the electronic device 100 and controls the display unit 12 to display the value.

With such a configuration, the time period for booting the electronic device 100 starts at the time the switch unit 13 is manually triggered, and ends at the time that the last step of “logging in” of the electronic device 100 is over. Thus, the time period is accurately timed.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. An electronic device comprising:
a display unit;
a booting control chip;
a switch unit, configured to send an electrical signal to the booting control chip when depressed; and
a main processing unit;
wherein the booting control chip comprises:
a booting sequence control module, configured for controlling the electronic device to boot in sequence when the electrical signal is received; and
a clock module, configured for starting timing and recording start time of a booting process when the electrical signal is received, stopping timing when the last booting step of the electronic device finishes under the control of the booting sequence control module and recording stop time of timing, and determining a value of time period for booting the electronic device according to the start time and the stop time of timing; and
the main processing unit configured to control the display unit to display the value of the time period for booting the electronic device.

2. The electronic device as described in claim 1, wherein the switch unit is electrically connected to a trigger pin of the booting control chip, and when the switch unit is depressed, the switch unit sends a logic high voltage signal to the trigger pin.

3. The electronic device as described in claim 1, further comprising a power management unit, which is electrically connected to the booting control chip, the display unit, and the main processing unit, for supplying power to the booting control chip, the display unit, and the main processing unit.

4. A method for detecting booting time period for an electronic device comprising a booting control chip, the step executed under the control of the booting control chip comprising:
starting timing and recording a start time of a booting process in response to a manual operation for booting the electronic device;
booting the electronic device in sequence; and
stopping timing and recording a stop time of timing when a last booting step of the electronic device finishes, and determining a value of time period for booting the electronic device according to the start time and the stop time of timing.

5. The method as described in claim 4, further comprising a step of displaying the value of the time period for booting the electronic device.
